(19) United States
(12) Patent Application Publication
(10) Pub. No.: US 2007/0129852 A1
(43) Pub. Date: Jun. 7, 2007

(54) On-line voice help system and method for automobile

(75) Inventors: Kuo-Rong Chen, Panchiao City (TW); Chun-Chung Lee, TunHou (TW); Cheng-Hung Huang, Kung Kuan (TW)

Correspondence Address: BACON & THOMAS, PLLC, 625 SLATERS LANE, FOURTH FLOOR, ALEXANDRIA, VA, 22314, US

(73) Assignee: Sin Etke Technology Co., Ltd., Taipei City (TW)

(21) Appl. No.: 11/452,301

(22) Filed: Jun. 14, 2006

(30) Foreign Application Priority Data
Dec. 6, 2005 (TW) 094142876

(51) Int. Cl. G05D 1/00; G05D 3/00; G06F 17/00; G06F 7/00

(52) U.S. Cl. 701/1

(57) ABSTRACT

An on-line voice help method used in an on-line voice help system includes the steps of: (a) driving an on-vehicle wireless communication module to send a current operation mode code to a wireless communication device, (b) driving a remote server to fetch the current operation mode code and then to search the corresponding voice response file from a voice response database subject to the fetched current operation mode code, (c) driving the remote server to control the wireless communication device to send the searched voice response file to the on-vehicle wireless communication module, and (d) driving a on-vehicle host to control an on-vehicle speaker to broadcast the searched voice response file.

### BACKGROUND OF THE INVENTION

1. Field of the Invention

The present invention relates to a voice help system and method and more particularly, to an on-line voice help system and method for automobile.

2. Description of Related Art

At the present time, many families have at least one motor vehicle for transportation. According to market investigation, consumers care not only about the performance and outer appearance of the vehicle but also the functions of the attached equipment, such as a theft-alarm function, navigation function or entertainment function.

A car generally has manuals of the attached equipment and which are received in the dashboard compartment for reference. However, a car driver cannot operate an on-vehicle electronic device and read the manual while driving the car. In this case, the driver may have to stop the car, and then search for the manuals and read the descriptions of the respective manual carefully so as to understand the operation of the on-vehicle electronic device. Thus, it clearly takes too much time to know the operation of the on-vehicle electronic device. Therefore, it is desirable to provide a remote announcement support service system and method so as to obtain the operation information of the on-vehicle electronic device immediately for the driver(s).

### SUMMARY OF THE INVENTION

The present invention has been accomplished under the circumstances in view. It is therefore the main object of the present invention to provide on-line voice help system and method for automobile that enables the car driver to obtain the operation information of every on-vehicle electronic device.

According to the present invention, the on-line voice help system comprises a wireless communication device, a voice response device, a remote server, an on-vehicle wireless communication module, an on-vehicle speaker, at least one on-vehicle electronic device, and an on-vehicle host. The on-vehicle wireless communication module, the on-vehicle speaker, the at least one on-vehicle electronic device and the on-vehicle host are installed in a motor vehicle.

Further, the voice response device comprises a voice response database, which has stored therein at least one voice response file. The remote server is electrically coupled to the wireless communication device and the voice response device. The at least one on-vehicle electronic device provides at least one operation mode to which an at least one mode code is corresponding, the at least one mode code each is stored in the voice response database and corresponding to the at least one voice response file. The on-vehicle host is electrically coupled to the on-vehicle wireless communication module, the on-vehicle speaker and the at least one on-vehicle electronic device respectively, whereby the on-vehicle host can control the on-vehicle wireless communication module to wirelessly send out a current operation mode code corresponding to the mode code of the at least one on-vehicle electronic device that is currently used during driving of the motor vehicle.

The remote server controls the wireless communication device to receive the current operation mode code from the on-vehicle wireless communication module, controls the voice response device to search out the voice response file from the voice response database corresponding to the received current operation mode code, and controls the wireless communication device to send the searched voice response file to the on-vehicle wireless communication module wirelessly. The on-vehicle host fetches the searched voice response file through the on-vehicle wireless communication module, and drives the on-vehicle speaker to broadcast the searched voice response file.

The on-line voice help method for automobile comprises the steps of: (A) driving an on-vehicle wireless communication module to send a current operation mode code to a wireless communication device, wherein the on-vehicle wireless communication module is carried in a motor vehicle; the current operation mode code is a mode code corresponding to the operation mode of one of at least one on-vehicle electronic device in the motor vehicle; the wireless communication device is electrically coupled to a remote server; (B) driving the remote server to fetch the current operation mode code and then to search at least one corresponding voice response file from the voice response database corresponding to the current operation mode code through a response host, wherein the remote server is electrically coupled to the response host and the voice response database; (C) driving the remote server to control the wireless communication device to send the searched voice response file to the on-vehicle wireless communication module; and (D) driving a on-vehicle host to control an on-vehicle speaker to broadcast the searched voice response file, wherein the on-vehicle host is carried in the motor vehicle and electrically coupled to the on-vehicle wireless communication module and the on-vehicle speaker.

The on-line voice help system and method for automobile helps the car driver operate every on-vehicle electronic device, saving a lot of inquiry time.

The aforesaid voice response device comprises a response host electrically coupled to the voice response database and the remote server.

The aforesaid at least one on-vehicle electronic device includes at least one of the electronic device group of: an on-vehicle theft-alarm device, an on-vehicle stereo device, and an on-vehicle navigation device.

The aforesaid on-vehicle theft-alarm device provides the at least one operation mode selected from at least one of the mode-group of a theft-alarm mode, and an emergency call mode.

The aforesaid on-vehicle stereo device provides the at least one operation mode selected from at least one of the mode-group of an MP3 play mode, a radio play mode, and a music CD play mode.

The aforesaid on-vehicle navigation device provides the at least one operation mode selected from at least one of the mode-group of a navigation mode, a landscape introduction mode, and a speeding warning mode.

The aforesaid at least one voice response file includes at least one of the voice response group of a theft-alarm mode voice file, an emergency call mode voice file, an MP3 play mode voice file, a radio play mode voice file, a music CD play mode voice file, a navigation mode voice file, a landscape introduction mode voice file, and a speeding warning mode voice file.

### BRIEF DESCRIPTION OF THE DRAWINGS

FIG. 1 illustrates the system architecture of an on-line voice help system for automobile according to the present invention.

FIG. 2 is a schematic drawing showing the various on-vehicle electronic devices of the present invention.

FIG. 3 is a flow chart of an on-line voice help method for automobile according to the present invention.

### DETAILED DESCRIPTION OF THE PREFERRED EMBODIMENT

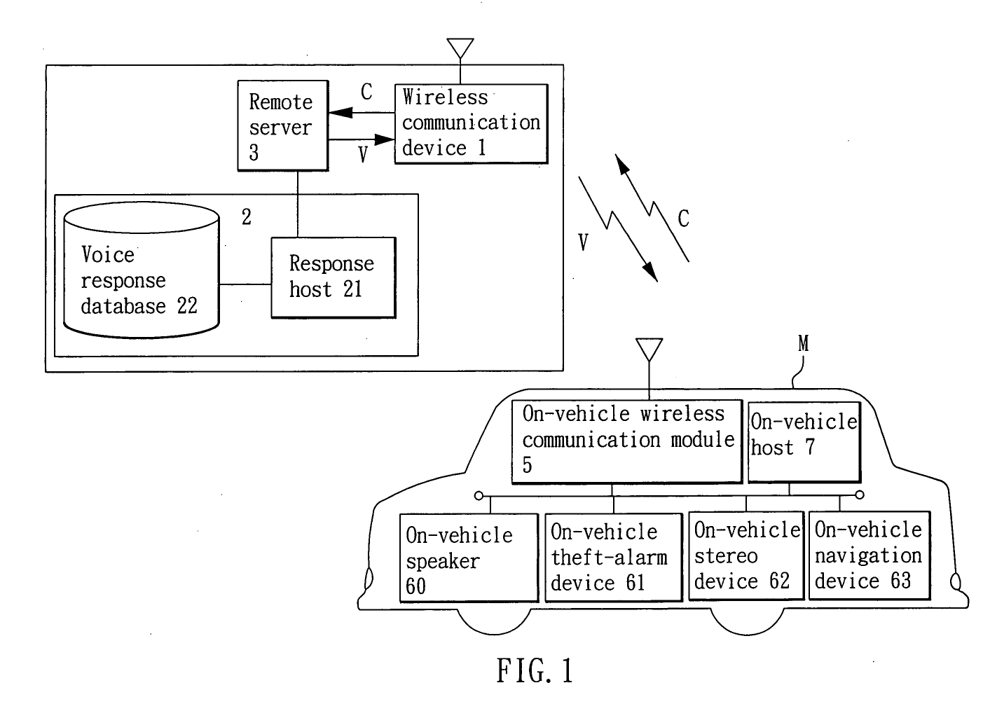

In the system architecture shown in FIG. 1, a car M has installed therein an on-vehicle wireless communication module 5, an on-vehicle host 7, a vehicle speaker 60, and three on-vehicle electronic devices. According to this embodiment, the on-vehicle wireless communication module 5 is a GSM (Global System for Mobile Communications) module; the three on-vehicle electronic devices are an on-vehicle theft-alarm device 61, an on-vehicle stereo device 62, and an on-vehicle navigation device 63.

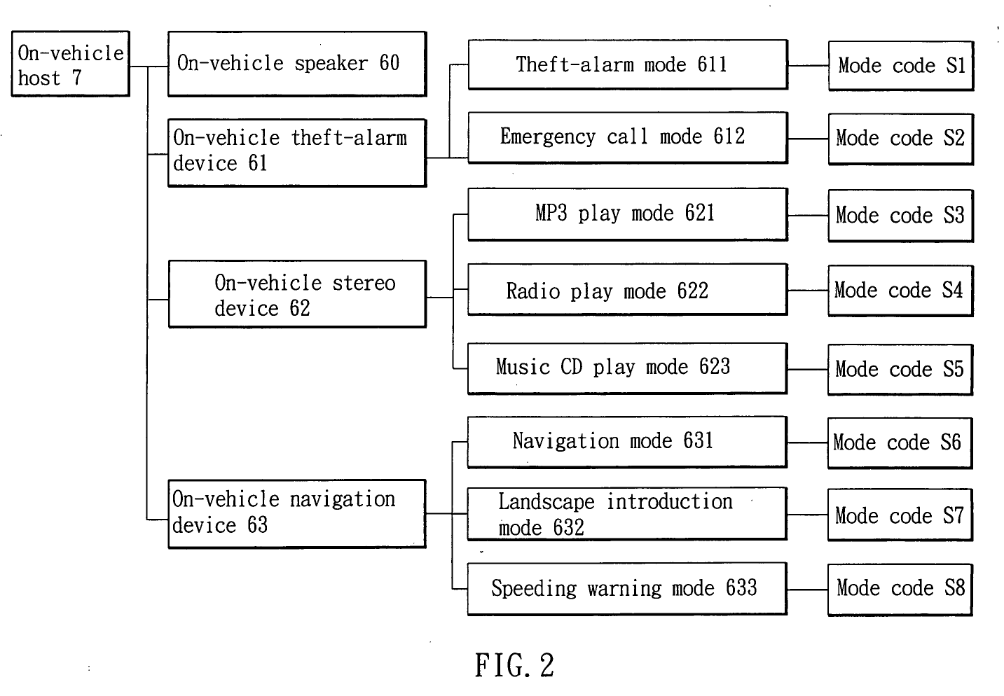

Referring to FIG. 2, the on-vehicle theft-alarm device 61 provides two operation modes, i.e., the theft-alarm mode 611 and the emergency call mode 612 respectively corresponding to mode code S1 and mode code S2; the on-vehicle stereo device 62 provides three operation modes, namely, the MP3 play mode 621, the radio play mode 622 and the music CD play mode 623 respectively corresponding to mode code S3, mode code S4 and mode code S5; the on-vehicle navigation device 63 provides three operation modes, namely, the navigation mode 631, the landscape introduction mode 632 and the speeding warning mode 633 respectively corresponding to mode code S6, mode code S7 and mode code S8.

The on-vehicle host 7 of the car M is electrically connected to the on-vehicle wireless communication module 5, the on-vehicle speaker 60, the on-vehicle theft-alarm device 61, the on-vehicle stereo device 62 and the on-vehicle navigation device 63, and controls the on-vehicle wireless communication module 5 to send out a current operation mode code C wirelessly.

The aforesaid current operation mode code C means the mode code S1˜S8 corresponding to the operation mode (the theft-alarm mode 611, emergency call mode 612, MP3 play mode 621, radio play mode 622, music CD play mode 623, navigation mode 631, landscape introduction mode 632 or speeding warning mode 633 of the on-vehicle theft-alarm device 61, on-vehicle stereo device 62 or on-vehicle navigation device 63) that is in operation.

Further, a voice response device 2 is shown comprising a response host 21 and a voice response database 22. The voice response database 22 has stored therein voice response files V including a theft-alarm mode vice file, an emergency call mode voice file, an MP3 play mode voice file, a radio play mode voice file, a music CD play mode voice file, a navigation mode voice file, a landscape introduction mode voice file, and a speeding warning mode voice file. These files V respectively correspond to the mode codes S1˜S8 of the operation modes (the theft-alarm mode 611, the emergency call mode 612, the MP3 play mode 621, the radio play mode 622, the music CD play mode 623, the navigation mode 631, the landscape introduction mode 632, and the speeding warning mode 633) of the aforesaid on-vehicle electronic devices (the on-vehicle theft-alarm device 61, the on-vehicle stereo device 62, and the on-vehicle navigation device 63).

The response host 21 of the voice response device 2 is electrically coupled to the voice response database 22 and a remote server 3. The remote server 3 is electrically coupled to a wireless communication device 1, and controls the wireless communication device 1 to receive the current operation mode code C from the on-vehicle wireless communication module 5, and also controls the voice response device 2 to search the voice response file V from the voice response database 22 corresponding to the current operation mode code C received C from the on-vehicle wireless communication module 5.

The remote server 3 also controls the wireless communication device 1 to transmit the searched voice response file V to the on-vehicle wireless communication module 5 of the car M wirelessly. The on-vehicle host 7 fetches the searched voice response file V through the on-vehicle wireless communication module 5, and controls the on-vehicle speaker 60 to broadcast the searched voice response file V.

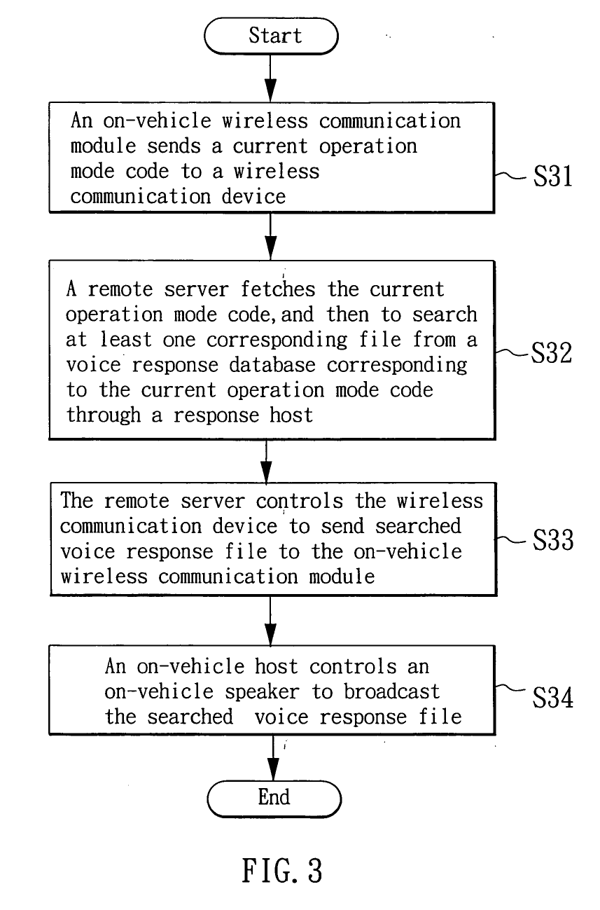

An on-line voice help method for automobile in accordance with the present invention is outlined hereinafter with reference to FIG. 3 and FIG. 1 again. When the driver is driving the car M and wants to play an MP3 music but does not know how to operate the on-vehicle stereo device 62 to play an MP3 music, the driver can press the inquire button (not shown) as the on-vehicle stereo device 62 is operating under the MP3 play mode 621, thus driving the on-vehicle wireless communication module 5 to send the mode code S3 corresponding to the MP3 play mode 621 of the on-vehicle stereo device 62 to the wireless communication device 1 wirelessly (Step S31). As stated above, the wireless communication device 1 is electrically coupled to the remote server 3.

Thereafter, the remote server 3 fetches the mode code S3, and then searches the corresponding MP3 play mode voice response file from the voice response database 22 (Step S32). As stated above, the remote server 3 is electrically coupled to the response host 21 and the voice response database 22. After having searched the corresponding MP3 play mode voice response file, the remote server 3 controls the wireless communication device 1 to send the searched MP3 play mode voice response file to the on-vehicle wireless communication module 5 wirelessly (Step S33). Finally, the on-vehicle host 7 controls the on-vehicle speaker 60 to broadcast the searched MP3 play mode voice response file (Step S34). As stated above, the on-vehicle host 7 is carried in the car M and electrically coupled to the on-vehicle wireless communication module 5 and the on-vehicle speaker 60.

The aforesaid on-line voice help system and method for automobile provide a real time voice inquiry function to help the driver operate the various electronic devices of the car when driving the car, thereby saving a lot of inquiry time. Similar to the aforesaid procedure, the driver can proceed with the operation of the other electronic devices of the car.

Although the present invention has been explained in relation to its preferred embodiment, it is to be understood that many other possible modifications and variations can be made without departing from the spirit and scope of the invention as hereinafter claimed.

What is claimed is:

1. An on-line voice help system for automobile, comprising:
a wireless communication device;
a voice response device, said voice response device comprising a voice response database, said voice response database having stored therein at least one voice response file;
a remote server electrically coupled to said wireless communication device and said voice response device;
an on-vehicle wireless communication module installed in a motor vehicle;
an on-vehicle speaker installed in said motor vehicle;
at least one on-vehicle electronic device installed in said motor vehicle, said at least one on-vehicle electronic device each providing at least one operation mode to which at least one mode code being corresponding, said at least one mode code each stored in said voice response database and corresponding to said at least one voice response file; and
an on-vehicle host installed in said motor vehicle and electrically coupled to said on-vehicle wireless communication module, said on-vehicle speaker and said at least one on-vehicle electronic device respectively, said on-vehicle host controlling said on-vehicle wireless communication module to wirelessly send out a current operation mode code corresponding to the mode code of the at least one on-vehicle electronic device that is currently used during driving of said motor vehicle;
wherein said remote server controls said wireless communication device to receive the current operation mode code from said on-vehicle wireless communication module, said remote server further controls said voice response device to search out the voice response file from said voice response database corresponding to the received current operation mode code, and said remote server further controls said wireless communication device to send the searched voice response file to said on-vehicle wireless communication module wirelessly; and
wherein said on-vehicle host fetches said searched voice response file through said on-vehicle wireless communication module, and drives said on-vehicle speaker to broadcast said searched voice response file.

2. The on-line voice help system for automobile as claimed in claim 1, wherein said voice response device comprises a response host electrically coupled to said voice response database and said remote server respectively.

3. The on-line voice help system for automobile as claimed in claim 1, wherein said at least one on-vehicle electronic device includes at least one of the electronic device group of: an on-vehicle theft-alarm device, an on-vehicle stereo device, and an on-vehicle navigation device.

4. The on-line voice help system for automobile as claimed in claim 3, wherein said on-vehicle theft-alarm device provides said at least one operation mode selected from at least one of the mode-group of a theft-alarm mode, and an emergency call mode.

5. The on-line voice help system for automobile as claimed in claim 3, wherein said on-vehicle stereo device provides said at least one operation mode selected from at least one of the mode-group of an MP3 play mode, a radio play mode, and a music CD play mode.

6. The on-line voice help system for automobile as claimed in claim 3, wherein said on-vehicle navigation device provides said at least one operation mode selected from at least one of the mode-group of a navigation mode, a landscape introduction mode, and a speeding warning mode.

7. The on-line voice help system for automobile as claimed in claim 1, wherein said at least one voice response file includes at least one of the voice response group of a theft-alarm mode voice file, an emergency call mode voice file, an MP3 play mode voice file, a radio play mode voice file, a music CD play mode voice file, a navigation mode voice file, a landscape introduction mode voice file, and a speeding warning mode voice file.

8. The on-line voice help system for automobile as claimed in claim 1, wherein said on-vehicle wireless communication module is a GSM module.

9. An on-line voice help method for automobile comprising the steps of:
(A) driving an on-vehicle wireless communication module to send a current operation mode code to a wireless communication device, wherein said on-vehicle wireless communication module is carried in a motor vehicle; said current operation mode code is a mode code corresponding to the operation mode of one of at least one on-vehicle electronic device in said motor vehicle; said wireless communication device is electrically coupled to a remote server;
(B) driving said remote server to fetch the current operation mode code and then to search at least one corresponding voice response file from a voice response database corresponding to said current operation mode code through a response host, wherein said remote server is electrically coupled to said response host and said voice response database;
(C) driving said remote server to control said wireless communication device to send the searched voice response file to said on-vehicle wireless communication module; and
(D) driving a on-vehicle host to control an on-vehicle speaker to broadcast the searched voice response file, wherein said on-vehicle host is carried in said motor vehicle and electrically coupled to said on-vehicle wireless communication module and said on-vehicle speaker.

10. The on-line voice help method for automobile as claimed in claim 9, wherein in step (A), said at least one on-vehicle electronic device includes at least one of the electronic device group of: an on-vehicle theft-alarm device, an on-vehicle stereo device, and an on-vehicle navigation device.

11. The on-line voice help method for automobile as claimed in claim 10, wherein in step (A), said on-vehicle theft-alarm device provides said at least one operation mode selected from at least one of the mode-group of a theft-alarm mode, and an emergency call mode.

12. The on-line voice help method for automobile as claimed in claim 10, wherein in step (A), said on-vehicle stereo device provides said at least one operation mode selected from at least one of the mode-group of an MP3 play mode, a radio play mode, and a music CD play mode.

13. The on-line voice help method for automobile as claimed in claim 10, wherein in step (A), said on-vehicle navigation device provides said at least one operation mode selected from at least one of the mode-group of a navigation mode, a landscape introduction mode, and a speeding warning mode.

14. The on-line voice help method for automobile as claimed in claim 9, wherein in step (B), said at least one voice response file includes at least one of the voice response group of a theft-alarm mode voice file, an emergency call mode voice file, an MP3 play mode voice file, a radio play mode voice file, a music CD play mode voice file, a navigation mode voice file, a landscape introduction mode voice file, and a speeding warning mode voice file.
